(19) United States
(12) Patent Application Publication
(10) Pub. No.: US 2005/0213449 A1
(43) Pub. Date: Sep. 29, 2005

(54) SLICE LEVEL CONTROL CIRCUIT

(75) Inventors: Tomonori Kamiya, Aichi-ken (JP); Takeshi Kura, Gifu-ken (JP); Naohiro Nishiwaki, Gifu-ken (JP)

Correspondence Address: FISH & RICHARDSON PC, P.O. BOX 1022, MINNEAPOLIS, MN, 55440-1022, US

(73) Assignee: SANYO ELECTRIC CO., LTD., Osaka (JP)

(21) Appl. No.: 10/907,064

(22) Filed: Mar. 18, 2005

(30) Foreign Application Priority Data
Mar. 24, 2004 (JP) 2004-086484

(51) Int. Cl. G11B 7/00

(52) U.S. Cl. 369/47.35; 369/44.25

(57) ABSTRACT

A slice level control circuit for obtaining optimal filter characteristics depending on optical disc data reading speed or optical disc condition, while achieving superior stability and response with respect to slice level. The control circuit cuts DC components in analog input signals to generate C-cut RF signals having adjusted DC levels. A comparator compares two C-cut RF signals to generate a binary RF signal for driving a charge pump circuit. An analog lowpass filter eliminates high-frequency components from the output signal of the charge pump circuit. An A/D converter circuit converts the cutoff output signal of the analog lowpass filter into a digital value signal according to sampling periods. A digital filter filters the digital value signal. A D/A converter converts the filtered digital value signal into an analog voltage signal. The analog voltage signal controls the slice level of the binary circuit.

### CROSS-REFERENCE TO RELATED APPLICATIONS

This application is based upon and claims the benefit of priority from the prior Japanese Patent Application No. 2004-086484, filed on Mar. 24, 2004, the entire contents of which are incorporated herein by reference.

### BACKGROUND OF THE INVENTION

The present invention relates to a slice level control circuit, and more particularly, to a slice level control circuit used in a reproduction device for optical discs such as CDs and DVDs.

Data recorded on an optical disc is formed, when viewed from a relatively long perspective, such that a high-level period (H-period) and a low-level period (L-period) have the same lengths. A slice level control circuit controls the slice level of input signals of such data so that the H-period and L-periods of sliced data have the same lengths.

A conventional slice level control circuit 100 will now be described with reference to FIG. 1. The conventional slice level control circuit 100 receives analog input signals including a forward phase signal 1a and a reverse phase signal 1b read from an optical disc. The forward phase signal 1a and the reverse phase signal 1b have the same amplitudes but opposite phases. The slice level control circuit 100 includes a circuit having a capacitor 2b and resistor 3b, connected in series, and a resistor 4b, with one end connected to a fixed voltage Vref and the other end connected to the resistor 3b. This circuit cuts off the direct current (DC) component in the reverse phase signal 1b to produce a C-cut RF signal 5b adjusted to a predetermined DC level. The slice level control circuit 100 further includes another circuit having a capacitor 2a and resistor 3a, connected in series, and a resistor 4a, with one end applied with a regulated voltage and the other end connected to the resistor 3a. This circuit cuts off the direct current (DC) component in the forward phase signal 1a to produce a C-cut RF signal 5a with an adjusted DC level.

A comparator 6 compares the C-cut RF signal 5a with the C-cut RF signal 5b and produces a binary RF signal 7, which is a binary output (binary data) for driving a charge pump circuit 8. The charge pump circuit 8 includes a P-channel charge pump 8-1 and an N-channel charge pump 8-2. As shown in FIG. 2, when the binary RF signal 7 is at high level, the N-channel charge pump 8-2 is driven. This converts the charge pump current to voltage with an analog filter 9, and the DC level of the C-cut RF signal 5a falls. Conversely, when the binary RF signal 7 is at low level, the P-channel charge pump 8-1 is driven. This converts the charge pump current to voltage with the analog filter 9, and the DC level of the C-cut RF signal 5a rises. A final change width of the DC level of the C-cut RF signal 5a is determined by the difference of the current amounts between the P-channel and N-channel charge pumps 8-1 and 8-2. In other words, if the H period is longer than the L period, the difference in current amounts will be a negative value. In this case, the DC level of the C-cut RF signal 5a falls and the H period is controlled to be shorter. If the L period is longer than the H period, the difference in current amounts will be a positive value. In this case, the DC level of the C-cut RF signal 5a rises and the L period is controlled to be shorter. In this manner, the DC level of the C-cut RF signal 5a is controlled so that the ratio of the H period and the L-period in the binary RF signal 7 is converged to 50%:50%.

The speed for reading data from an optical disc is set to various speeds. For CDs, for example, the data read speed may be set to 1×, 4×, and up to 56×. For DVDs, the speed may be set to 1×, 4×, and up to 16× (96× in terms of CD reading speed). By setting the data read speed in this manner, the frequency bands of the analog input signals 1a and 1b is changed by about 100 times. As a result, the frequency band of the binary RF signal 7 is also changed by about 100 times. To be used with such frequency band changed by 100 times, the analog filter 9 must have superior stability and superior response with respect to the change in the DC level of the analog input signals 1a and 1b. In other words, even if the DC level of the analog input signal 1a and 1b changes instantaneously, the output of the analog filter 9 is required to remain stable, keeping the slice level unchanged. On the other hand, if the DC level changes gradually, the output of the analog filter 9 must be generated such that the slice level changes follow the gradual change of the DC level. The corresponding frequency for achieving superior stability and superior response differs for each speed for reading data from an optical disc. Therefore, a conventional analog filter has a plurality of individual filters, each having a different filter property so that an individual filter is selected to suit the current read speed. For example, in FIG. 1, the analog filter 9 includes four individual filters 9-1 to 9-4. FIG. 3 is a graph showing the relationship between gain and frequency in each of the individual filters. When the speed for reading data from the optical disc is relatively low, the frequency band followed by the slice level control circuit is relatively low and hence the individual filter 9-1 is selected. As the speed for reading data from the optical disc increases, the selected individual filter shifts from 9-1 to 9-2, to 9-3, and then to 9-4.

However, a plurality of control signals need be used for selecting one of the individual filters. This requires a plurality of terminals for the control signals and thus inhibits reduction in chip size. Additionally, a large number of external components for configuring the individual filters are necessary (e.g., capacitors Ci1 and Ci2, and resistors Ri (i representing an integer from 1 to 4)). Furthermore, when the jitter fluctuation of data recorded on an optical disc is large and the response of the analog filter 9 should be lowered to ensure stability or when the defect properties should be optimized according to reproduction speed to improve playability, it is difficult to alter the filter properties of the analog filter 9 in a manner optimal for each case.

### SUMMARY OF THE INVENTION

The present invention provides a slice level control circuit that easily obtains the optimal filter property in accordance with the speed for reading data from an optical disc or in accordance with the optical disc condition, while achieving superior slice level stability and response.

One aspect of the present invention is a circuit for controlling a slice level. The circuit includes a comparator for performing binary conversion on an analog input signal to generate a binary output signal. A charge pump circuit connected to the comparator operates in accordance with the binary output signal to generate a charge pump output signal. An analog lowpass filter, connected to the charge pump circuit, cuts off the charge pump output signal at a first cutoff frequency to generate a cutoff output signal. An A/D converter connected to the analog lowpass filter converts the cutoff output signal into a digital value signal. A digital filter connected to the A/D converter performs predetermined filtering processing on the digital value signal to generate a filtered digital value signal. A D/A converter connected to the digital filter converts the filtered digital value signal into an analog voltage signal. The analog voltage signal is fed back to the comparator.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic circuit diagram showing a conventional slice level control circuit;

FIG. 2 is a waveform diagram illustrating operations for a charge pump circuit in the slice level control circuit of FIG. 1;

FIG. 3 is a graph showing the relationship between gain and frequency in individual filters of the slice level control circuit in FIG. 1;

FIG. 4 is a schematic circuit diagram showing a slice level control circuit according to a preferred embodiment of the present invention;

FIG. 5 is a schematic block diagram showing the digital filter of the slice level control circuit in FIG. 4;

FIG. 6 is a graph showing the relationship between gain and frequency in various parts of the digital filter; and

FIG. 7 is a waveform diagram illustrating the processing performed when an optical disc is scratched.

### DETAILED DESCRIPTION OF THE PREFERRED EMBODIMENTS

In the drawings, like numerals are used for like elements throughout.

A slice level control circuit 200 according to a preferred embodiment of the present invention will now be described with reference to FIG. 4. The slice level control circuit 200 receives analog input signals read from an optical disc and including a forward phase signal 1a and a reverse phase signal 1b. The forward phase signal 1a and the reverse phase signal 1b have the same amplitudes but opposite phases. The slice level control circuit 200 has a circuit including a capacitor 2b and a resistor 3b, connected in series, and a resistor 4b, one end of which is connected to a fixed voltage Vref and the other end of which is connected to a node between the resistor 3b and the inverting input terminal of a comparator 6. This circuit cuts off the direct current (DC) component in the reverse phase signal 1b to produce a C-cut RF signal 5b adjusted to a predetermined DC level. The slice level control circuit 200 has another circuit including a capacitor 2a and a resistor 3a, connected in series, and a resistor 4, one end of which is applied with a regulated voltage from a D/A converter 13 (described later) and the other end of which is connected to the non-inverting input terminal of the comparator 6. This circuit cuts off the direct current (DC) component in the forward phase signal 1a to produce a C-cut RF signal 5a with an adjusted DC level.

The comparator 6 compares the C-cut RF signal 5a with the C-cut RF signal 5b and produces a binary RF signal 7 that is a binary output (binary data) for driving a charge pump circuit 8. The charge pump circuit 8 includes a P-channel charge pump 8-1 and an N-channel charge pump 8-2. The N-channel charge pump 8-2 is driven when the binary RF signal 7 is at a high level, and the P-channel charge pump 8-1 is driven when the binary RF signal 7 is at a low level.

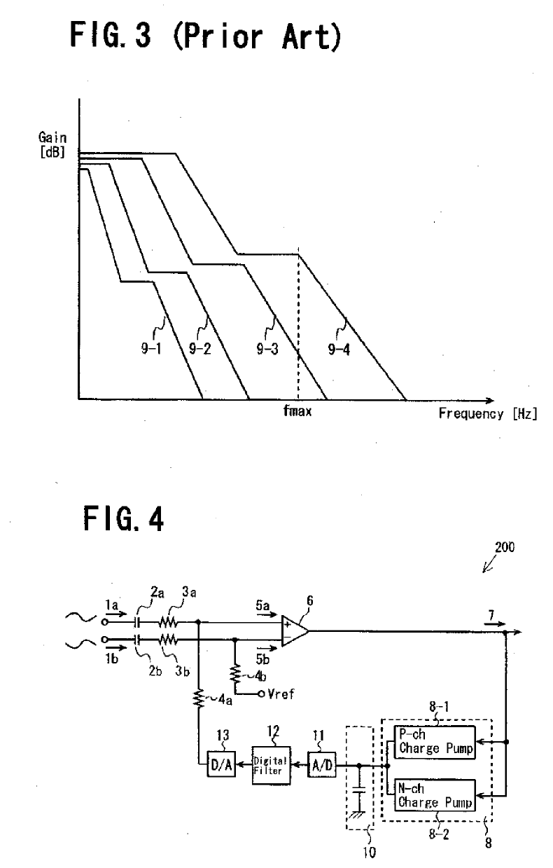

An analog lowpass filter 10 cuts off the output signal of the charge pump circuit 8 at a first cutoff frequency. The first cutoff frequency is set based on the maximum read speed of an analog input signal read from an optical disc. A frequency band greater than or equal to the first cutoff frequency is a band that does not have to be followed by the slice level. In other words, if the slice level follows a frequency band that is greater than or equal to the first cutoff frequency, the slice level will follow short fluctuations of data and become instable. In the example shown in FIG. 3, the first cutoff frequency is set to fmax or to a frequency slightly higher than fmax. The first cutoff frequency is required to be set to a cutoff frequency that will not produce aliasing from the sampling frequency of a downstream A/D converter 11.

The A/D converter 11 receives an output signal from the analog lowpass filter 10, converts the output signal into a digital value signal in accordance with sampling periods, and provides the digital value signal to a digital filter 12. The digital filter 12 performs predetermined filtering processing on the digital value signal provided in accordance with the sampling periods, and provides the filtered digital value signal to a D/A converter 13. The D/A converter 13 converts the filtered digital value signal into an analog voltage. The DC level of the C-cut RF signal 5a is controlled by the analog voltage output from the D/A converter 13.

The present embodiment employs a configuration combining the analog lowpass filter 10 and the digital filter 12 for the analog input signals 1a and 1b of which frequency bands vary depending on the setting of the speed for reading data from an optical disc. The frequency band of the output signal from the charge pump circuit 8 is considerably high. Thus, the processing is divided between the analog lowpass filter 10, which is superior in high-speed processing and thus processes the signal, and the digital filter 12, which has high accuracy, high flexibility, and a superior capability for storing the processing results and thus processes the output signal from the analog lowpass filter 10. As a result, the slice level is appropriately controlled while realizing superior stability and superior response with respect to changes in the DC level of the analog input signals 1a and 1b.

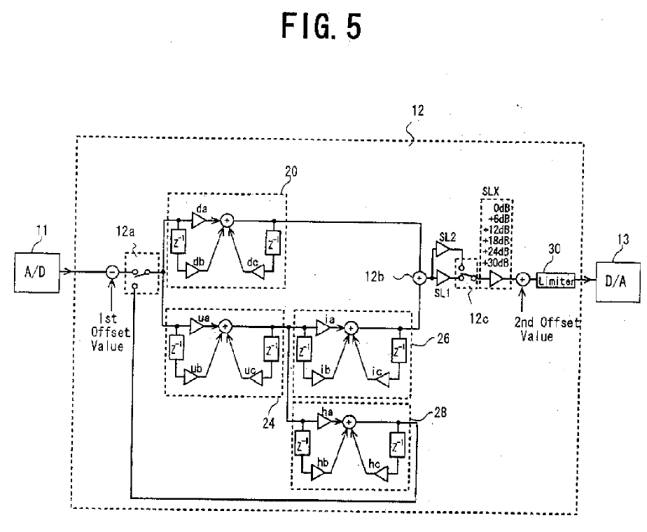

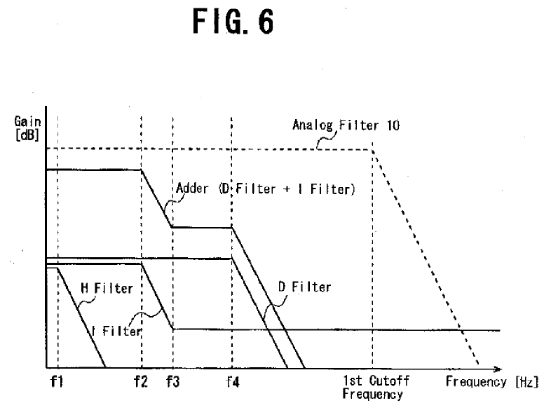

The configuration of the digital filter 12 will now be described in detail with reference to FIG. 5. The digital filter 12 includes three bilinear-transformation digital lowpass filters, namely, a D filter 20, a U filter 24, and an H filter 28, and one bilinear-transformation digital low boost filter, namely an I filter 26. The D filter 20, the I filter 26, and the H filter 28 have a gain-to-frequency characteristic, for example, as shown in FIG. 6.

The digital filter 12 first subtracts a first offset value from a digital value provided by the A/D converter 11. The first offset value is set to cancel a parasitic offset produced in the slice level control circuit 200 by the charge pump circuit 8, the analog lowpass filter 10, the A/D converter 11, the D/A converter 13, etc. of the slice level control circuit 200.

The digital value obtained by the subtraction of the first offset value is provided to the D filter 20 and the U filter 24 via a switching circuit 12a. The switching circuit 12a normally selects the digital value obtained by subtracting the first offset value. The D filter 20 is a lowpass filter for cutting frequency components that are greater than or equal to frequency f4 at 6 dB/oct.

The U filter 24 performs filtering processing to remove high frequency components and prevent aliasing from being produced in the following I filter 26 and H filter 28. The I filter 26 is a low boost filter for cutting frequency components in the range of frequency f2 to frequency f3 in the digital value provided by the U filter 24 at 6 dB/oct and for maintaining the frequency components greater than or equal to frequency f3 at a constant gain. The H filter 28 is a lowpass filter for cutting frequency components greater than or equal to frequency f1, which is lower than the cutoff frequency of the I filter 26, at 6 dB/oct. In other words, the H filter 28 is a lowpass filter through which only low frequency components that are very close to the DC component of the signal provided to the digital filter 12.

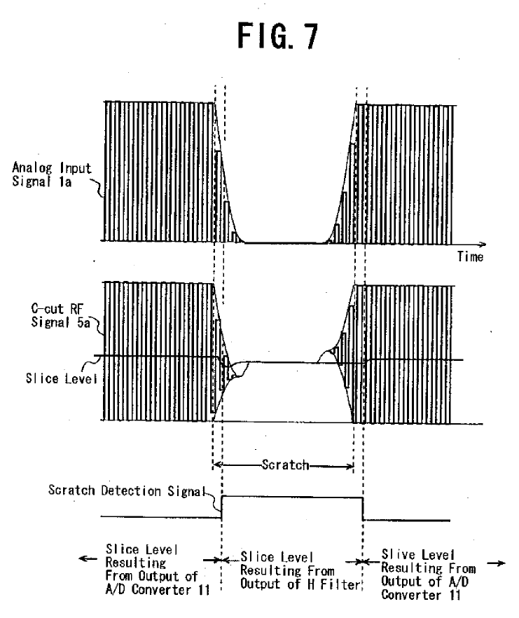

The switching circuit 12a normally selects the digital value obtained by subtracting the first offset value. However, if the amplitude of the analog input signal 1a (and analog input signal 1b) read from an optical disc suddenly becomes small, as shown in FIG. 7, due to a scratch or the like on the optical disc, a scratch detection signal is provided by a control circuit (not shown) to the switching circuit 12a. In response to the scratch detection signal, the switching circuit 12a temporarily selects the output from the H filter 28 as the slice level. The switching is performed in order to prevent the slice level from changing excessively due to a temporary factor, such as a scratch, so that the appropriate slice level (the slice level at the time when the scratch is detected) is promptly selected after recovering from the scratch.

An adder 12b adds the output from the D filter 20 and the output from the I filter 26. Therefore, the gain of the adder 12b exhibits frequency characteristics as shown in FIG. 6. That is, the adder 12b has a high gain for frequency components that are less than or equal to frequency f2, cuts frequency components from frequency f2 to frequency f3 at 6 dB/oct, has a constant gain for frequency components from frequency f3 to f4, and cuts frequency components greater than or equal to frequency f4 at 6 dB/oct.

In the digital filter 12, the gain from frequency f1 to frequency f4 and the gain in each frequency band may be set to any value by setting appropriate multiplier factors (da, db, dc, ua, ub, uc, ia, ib, ic, ha, hb, and hc) respectively for the D filter 20, the U filter 24, the I filter 26, and the H filter 28.

The output signal from the adder 12b is provided to a plurality of multipliers SL1 and SL2, which perform multiplication with respective predetermined coefficients. The multiplication coefficient of the multiplier SL2 is greater than the multiplication coefficient of the multiplier SL1. A selector 12c selects either one of the outputs from the multipliers SL1 and SL2 according to a switching control signal from a control circuit (not shown). If the optical disc has a local scratch, the selector 12c selects the output from the multiplier SL2, which has a larger multiplication coefficient. This is because the output from the multiplier SL2 is more preferable for the slice level to promptly follow the slice level of a signal provided to the digital filter 12 after recovering the scratch. A multiplier SLX multiplies the output from the selector 12c. The multiplication by the multiplier SLX includes carrying or borrowing digits in the binary number system.

A second offset value is added to the output of the multiplier SLX. It is sometimes desirable for the reproduction operation to offset the slice level deliberately from the center depending on the recording condition of the optical disc. The second offset value is applied in such case. A limiter 30 limits the output to which the second offset value has been added to prevent the digital filter 12 from providing an excessively responsive output. This outputs a limited digital value from the digital filter 12.

The digital filter 12 may be embodied through any means, such as an exclusive hardware, a digital signal processor, or a software program.

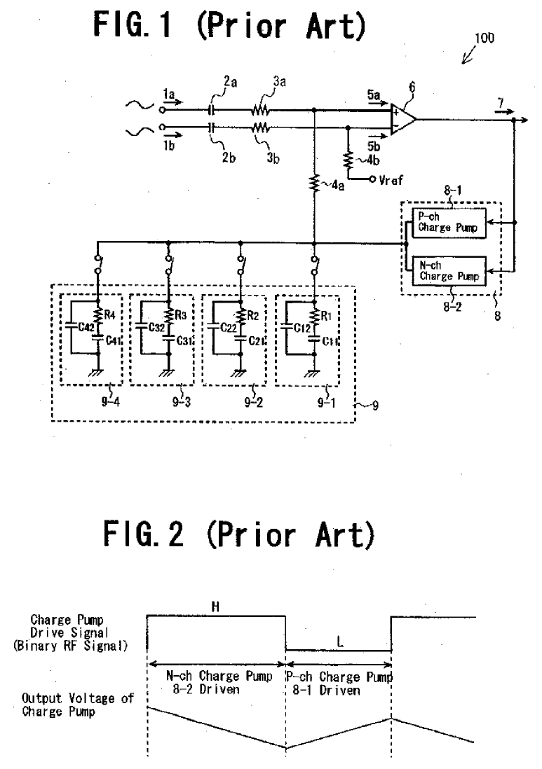

As described above, the frequency characteristics of the gain of the analog lowpass filter 10, the A/D converter 11, the digital filter 12 and the D/A converter 13 may correspond to the frequency characteristics of the gain of any of the individual filters 9-1 to 9-4 in FIG. 1. Therefore, the slice level control circuit 200 of the present invention enables the optimal filter characteristics to be easily and quickly obtained depending on the speed for reading data from the optical disc or the condition of the optical disc. Thus, the slice level control circuit 200 achieves superior stability and response with respect to the slice level. Furthermore, control signal terminals for selecting a plurality of individual filters are not necessary as in the prior art. This reduces the chip size. Additionally, since no individual filters are required, the number of external parts and components may be reduced.

It should be apparent to those skilled in the art that the present invention may be embodied in many other specific forms without departing from the spirit or scope of the invention. Therefore, the present examples and embodiments are to be considered as illustrative and not restrictive, and the invention is not to be limited to the details given herein, but may be modified within the scope and equivalence of the appended claims.

1. A circuit for controlling a slice level, the circuit comprising:
a comparator for performing binary conversion on an analog input signal to generate a binary output signal;
a charge pump circuit, connected to the comparator, for operating in accordance with the binary output signal to generate a charge pump output signal;
an analog lowpass filter, connected to the charge pump circuit, for cutting off the charge pump output signal at a first cutoff frequency to generate a cutoff output signal;
an A/D converter, connected to the analog lowpass filter, for converting the cutoff output signal into a digital value signal;
a digital filter, connected to the A/D converter, for performing predetermined filtering processing on the digital value signal to generate a filtered digital value signal; and
a D/A converter, connected to the digital filter, for converting the filtered digital value signal into an analog voltage signal, the analog voltage signal being fed back to the comparator.

2. The circuit according to claim 1, wherein the digital filter includes:
a first digital lowpass filter for receiving the digital value signal provided by the A/D converter to generate a first filtered digital value signal;
a first digital low boost filter for receiving the digital value signal provided by the A/D converter to generate a second filtered digital value signal; and
an adder, connected to the first digital lowpass filter and the first digital low boost filter, for adding the first and second filtered digital value signals to generate an added digital value signal.

3. The circuit according to claim 2, wherein the digital filter further includes:
a plurality of multipliers, connected to the adder, for multiplying the added digital value signal by a predetermined coefficient to generate a plurality of multiplied digital value signals; and
a selector, connected to the plurality of multipliers, for selectively outputting the plurality of multiplied digital value signals.

4. The circuit according to claim 3, wherein:
the plurality of multipliers include a first multiplier, having a first predetermined coefficient, and a second multiplier, having a second predetermined coefficient that is greater than the first predetermined coefficient; and
the selector outputs a digital value signal generated by the second multiplier when the amplitude of the analog signal suddenly becomes small and then the amplitude returns to its original level.

5. The circuit according to claim 2, wherein:
the first digital lowpass filter cuts a digital value signal having a frequency component that is greater than or equal to a first frequency; and
the first digital low boost filter cuts a digital signal having a frequency component within a frequency band that is lower than the first frequency.

6. The circuit according to claim 2, wherein:
the first digital lowpass filter cuts a digital value signal having a frequency component that is greater than or equal to a first frequency; and
the first digital low boost filter cuts a digital value signal having a frequency component within a frequency band between a second frequency, which is lower than the first frequency, and a third frequency, which is lower than the second frequency, to keep the gain constant for the digital value signal corresponding to a frequency greater than or equal to the second frequency.

7. The circuit according to claim 2, wherein the digital filter further includes:
a second digital lowpass filter for receiving the digital value signal provided by the A/D converter and providing a third filtered digital value signal to the first digital low boost filter in order to cope with aliasing in the first digital low boost filter.

8. The circuit according to claim 2, wherein the digital filter further includes:
a second digital lowpass filter for receiving the digital value signal provided by the A/D converter and enabling passage of only a digital value signal having a frequency component that is lower than the filter frequency of the first digital low boost filter to generate a third filtered digital value signal; and
a switching circuit for selectively providing the digital value signal provided by the A/D converter and the third filtered digital value signal to the first digital lowpass filter and the first digital low boost filter.

9. The circuit according to claim 8, wherein the digital filter further includes:
a third digital lowpass filter for receiving the digital value signal provided by the A/D converter and providing a fourth filtered digital value signal to the first digital low boost filter and the second digital lowpass filter in order to cope with aliasing in the first digital low boost filter and the second digital lowpass filter.

10. The circuit according to claim 8, wherein the digital value signal has a DC component, and the second digital lowpass filter enables passage of only a digital value signal having a frequency component very close to the DC component.

11. The circuit according to claim 8, wherein the switching circuit provides the third filtered digital value signal to the first digital lowpass filter and the first digital low boost filter when the amplitude of the analog input signal suddenly becomes small.
